(19) United States
(12) Patent Application Publication
(10) Pub. No.: US 2014/0183996 A1
(43) Pub. Date: Jul. 3, 2014

(54) Magnetic Powertrain and Components

(71) Applicants: Jing He, (US); Hongping He, (US)

(72) Inventors: Jing He, Davis, CA (US); Hongping He, Bakersfield, CA (US)

(73) Assignees: Hongping He, Bakersfield, CA (US); Jing He, Bakersfield, CA (US)

(21) Appl. No.: 13/731,003

(22) Filed: Dec. 29, 2012

(51) Int. Cl. H02K 49/10; H02K 7/065

(52) U.S. Cl. CPC H02K 49/102; H02K 7/065
USPC 310/74; 310/103

(57) ABSTRACT

Magnetic powertrains for vehicles comprised of magnetically integrated transmission systems and components built from a plurality of magnetic gears are provided. Embodiments provide magnetic clutches, magnetic differentials, and assemblies of kinetic-electric CVTs integrating one or more motors with a flywheel by the use of magnetic gears.

### CROSS REFERENCE TO RELATED APPLICATION(S)

This application claims priority from U.S. Provisional Patent Application Ser. No. 61/581,341 filed Dec. 29, 2011, which is incorporated by reference herein.

### BACKGROUND OF THE INVENTION

1. Field of the Invention

The present invention pertains to powertrains and powertrain components. In general the present invention relates to magnetic gear components that may be used to replace mechanical gear components in many industrial and engineering applications, and more specifically the present invention relates to vehicle powertrains.

2. Description of the Related Art

Mechanical gearboxes have been in use for thousands of years and are prevalent in most engineering applications involving transfer of torque from a power source. In more recent years, however, a type of flux modulating magnetic gears have been invented and developed as prototypes (K. Atallah and D. Howe: A Novel High-Performance Magnetic Gear: IEEE Transactions on Magnetics, Vol. 37, No. 4, pp. 2844-2846). Whereas mechanical gears are worn down by friction over time and require maintenance and lubrication, magnetic gears are contactless and thus have higher efficiency and increased reliability, since there is no friction between magnetic gears. Magnetic gears can also eliminate the need for seals on input/output shafts and can operate over a larger temperature range because they do not rely on oil and seals. An additional benefit of flux modulating magnetic gears is that they have higher torque density, and may be smaller and more lightweight than mechanical gears rated for the same torque.

In the prior art considerable efforts have been made to increase the strength and efficiency of flux modulating magnetic gears (U.S. Pat. No. 7,973,441 by Atallah and document US-2012/0194021 by Nakatsugawa, et. al). It is also known that this type of magnetic gear can be integrated into electric motors so that the resulting machines exhibit higher torque densities compared to conventional motors while still maintaining a power factor of 0.9 or higher in some circumstances, as described by U.S. Pat. No. 7,982,351 by Atallah. The development of magnetic gears integrated into electric motors has had much of the focus of magnetic gear research in the prior art. Yet there is still much potential to improve the efficiency and torque capabilities of other powertrain components by using this technology, especially for vehicle applications.

### SUMMARY OF THE INVENTION

In the present invention, magnetic gears are used in magnetic powertrain components suitable for building vehicle powertrains. In designing these magnetic powertrain components, it is understood that the speed relationship among magnetic gear elements is analogous to the speed relationship among planetary gear elements, which are used often in powertrains.

One aspect of the present invention implements magnetic clutches comprised of magnetic gears. Simpler magnetic clutches can be disengaged or engaged with one gear ratio. Compound magnetic clutches have two selectable gear ratios when engaged.

In another aspect, magnetic gear elements are used advantageously as a magnetic differential drive, replacing mechanical differential drives in a powertrain. Magnetic differentials do not rely on oil and may function over a wider range of temperatures than mechanical differentials.

Another aspect provides a magnetic CVT that integrates two electric motors with a magnetic gear set that can save rotor magnets.

In another aspect of the present invention, the high-speed permanent magnet rotor of a magnetic gear set is integrated into a flywheel, which can be sealed into a vacuum and variated either by mechanical or electric means, and forms a kinetic power system.

Another aspect of the present invention integrates one or more electric motors and a kinetic power system to form a kinetic-electric hybrid CVT assembly that has kinetic and electric power sources, and provides a continuously variable speed ratio between the input port and the output port of the assembly. The purpose of such an assembly is to optimize the efficiency of the primary power source of the vehicle powertrain, be it a traction motor integrated within the kinetic-electric hybrid CVT assembly or an internal combustion engine coupled to the input port of the assembly.

In further aspects, the invention combines a plurality of magnetic gears and magnetic powertrain components into powertrains for conventional vehicles, electric vehicles, and hybrid vehicles.

Advantages of magnetic powertrain components and magnetic powertrains may include smaller size and weight, high torque density, high efficiency, increased reliability and durability, low noise, and better performance at low temperatures.

### BRIEF DESCRIPTION OF THE DRAWINGS

FIG. 1(a) represents the basic components of a planetary gear set and the speed relationships between the components in a planetary gear set, according to an embodiment;

FIG. 1(b) illustrates the basic elements of a flux modulating magnetic gear set, and shows the speed relationships between the components of the magnetic gear set, according to an embodiment;

FIG. 1(c) depicts a schematic representation of the disc-shaped or “pancake” type magnetic gear set shown in FIG. 1(b), according to an embodiment;

FIG. 1(d) depicts a schematic representation of a magnetic gear set in a cylindrical configuration, which is functionally equivalent to FIG. 1(b), according to an embodiment;

FIGS. 2(a), 2(b), and 2(c) respectively depict a magnetic gear set in which the low-speed magnetic rotor is grounded, the high-speed magnetic rotor is grounded, and the magnetic flux conducting element is grounded, according to an embodiment;

FIG. 3(a) shows a motor with magnetic gears integrated, wherein the high-speed magnetic rotor also serves as the motor's rotor, according to an embodiment;

FIG. 3(b) depicts a magnetic gear set that is integrated into two motors to form a CVT wherein the magnetic flux conducting element is the input port and the low-speed magnetic rotor is the output port, according to an embodiment;

FIG. 3(c) depicts a magnetic gear set that is integrated into two motors to form a CVT wherein the high-speed magnetic rotor is the input port and the magnetic flux conducting element is the output port, according to an embodiment;

FIG. 3(d) depicts the cylindrical form equivalent of FIG. 3(a);

FIGS. 4(a), 4(b), and 4(c) depict configurations of magnetic clutches comprised of a magnetic gear set in which one element is connected to a brake, according to an embodiment;

FIGS. 5(a) and 5(b) demonstrate two possible embodiments of a compound magnetic clutch, each with two selectable gear ratios, according to an embodiment;

FIG. 6(a) illustrates a magnetic differential drive, according to an embodiment;

FIG. 6(b) illustrates an alternative embodiment of a magnetic differential drive, according to an embodiment;

FIG. 6(c) illustrates a magnetic differential drive in a cylindrical configuration, according to an embodiment;

FIGS. 7(a) and 7(b) show how the magnetic gear set may be integrated with a flywheel into a kinetic power system, according to an embodiment;

FIGS. 7(c) and 7(d) respectively demonstrate a single-motor wheel hub implementation of a kinetic power system and a dual-motor wheel hub implementation of a kinetic power system, both utilizing magnetic gears, according to an embodiment;

FIGS. 8(a), 8(b), and 8(c) show various gear selecting transmissions comprised of magnetic gear sets and magnetic clutches, according to an embodiment;

FIGS. 9(a) and 9(b) illustrate how various magnetic gear components may be used together so as to comprise a powertrain for a typical internal combustion engine powered vehicle, according to an embodiment;

FIGS. 10(a) and 10(b) demonstrate ways kinetic power systems may be added to the powertrains of FIGS. 9(a) and 9(b), respectively, according to an embodiment;

FIG. 11(a) shows a single-motor electric vehicle powertrain comprised of a kinetic-electric hybrid CVT assembly, according to an embodiment;

FIG. 11(b) shows a dual-motor electric vehicle powertrain comprised of a kinetic-electric hybrid CVT assembly, according to an embodiment;

FIGS. 12(a) and 12(b) show embodiments of magnetic powertrains for hybrid vehicles having an ICE engine and electric motors for power sources, according to an embodiment;

FIG. 13(a) illustrates a kinetic-electric vehicle powertrain comprised of magnetic powertrain components where there is one electric motor as the primary power source, and that motor is integrated into a kinetic-electric hybrid CVT assembly, according to an embodiment;

FIG. 13(b) demonstrates a kinetic-electric vehicle powertrain comprised of magnetic powertrain components where there are two electric motors as the primary power source, one of which is integrated with magnetic gears, according to an embodiment;

FIG. 13(c) depicts a kinetic-electric vehicle powertrain comprised of magnetic powertrain components where there are two electric motors as the primary power source, both of which are magnetically integrated into a kinetic-electric hybrid CVT assembly, according to an embodiment;

FIG. 13(d) shows a kinetic-electric vehicle powertrain comprised of magnetic powertrain components where there are two electric motors as the primary power source, both of which are magnetically integrated into a kinetic-electric hybrid CVT assembly, and the flywheel in the assembly can be disengaged through a clutch, according to an embodiment;

FIG. 14(a) shows a magnetically integrated three-port hybrid vehicle powertrain wherein two motors, a flywheel, and/or an internal combustion engine can drive the vehicle, according to an embodiment;

FIG. 14(b) presents a magnetically integrated four-port hybrid vehicle powertrain wherein two motors, a flywheel, and/or an internal combustion engine can drive the vehicle, according to an embodiment;

FIG. 14(c) illustrates a three-port hybrid vehicle powertrain with a kinetic-electric CVT assembly integrating two motors and a flywheel, according to an embodiment; and

FIG. 14(d) illustrates a three-port hybrid vehicle powertrain with a kinetic-electric CVT assembly integrating three motors and a flywheel, according to an embodiment.

### DESCRIPTION OF THE PREFERRED EMBODIMENT(S)

Embodiment(s) of the present invention are described herein with reference to the drawings. In the drawings, like reference numerals represent like elements.

### Magnetic Gear Structure and Principles

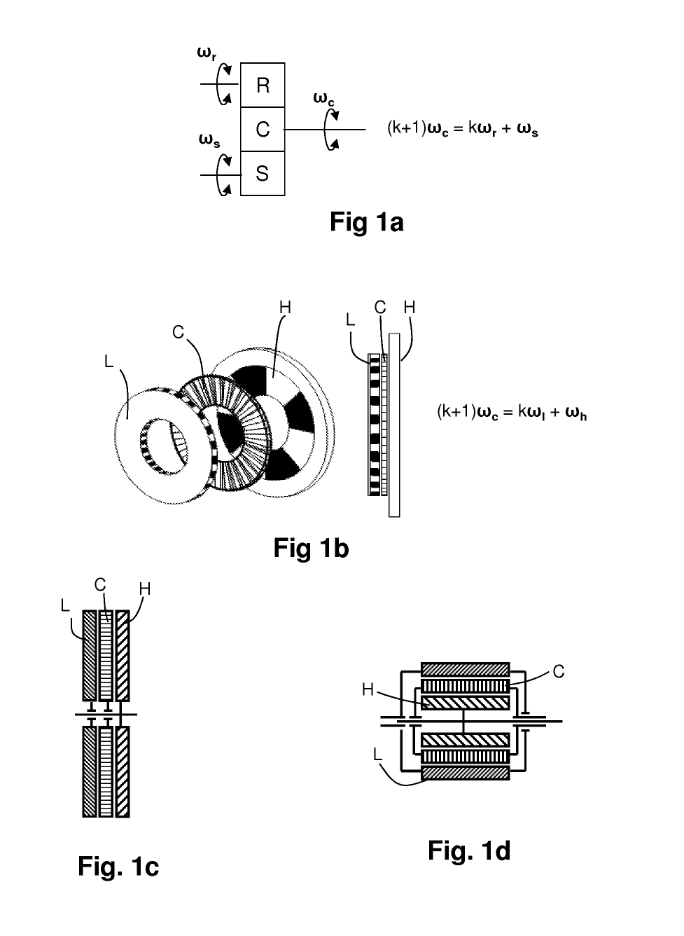

FIG. 1(a) shows a representation of a planetary gear set; there are three input/output ports: the ring gear R, planet carrier C, and sun gear S. A port is a location on a rotational structure that can drive movement, such as a shaft end or surface, or a face or edge of a gear. A port may be a rotatable element. The speeds of these three input/output ports are related by the equation

(k+1)ω_{c}=kωᵣ+ωₛ (1)

ω_{c} denotes the angular speed of the planet carrier, ωᵣ denotes the angular speed of the ring gear, and ωₛ denotes the angular speed of the sun gear; k represents the ratio between the quantity of teeth in the ring gear R and the quantity of teeth in the sun gear S.

FIG. 1(b) illustrates a disc-shaped or “pancake” magnetic gear set configuration. The higher speed magnetic rotating element with a lower quantity of magnetic pole pairs is referred to as the high-speed rotor H. The lower speed magnetic rotating element with a higher quantity of magnetic pole pairs is referred to as the low-speed rotor L. The intermediate rotating element between H and L with ferrous pole-pieces conducting magnetic flux between H and L is referred to as the magnetic flux conducting element or rotor C.

On both the high-speed rotor H and the low-speed rotor L there are various magnets, forming magnetic poles that radiate out from the central axis of rotation for both. The rotor with a relatively fewer quantity of magnetic poles spins at a faster speed, and is thus the high-speed rotor; the rotor with a relatively larger quantity of magnetic poles spins more slowly, so it is the low-speed rotor. Sandwiched in between the high-speed rotor H and the low-speed rotor L is another rotor C that has ferrous pieces arranged to conduct magnetic field lines and to modulate the magnetic flux or the magnetic field between rotors H and L when rotated. Similar to the planetary gear set, this magnetic gear set also has three input/output ports, namely the high speed rotor H, low speed rotor L, and the magnetic flux conducting rotor C. In the prior art, it was discovered that when the quantity of ferrous pieces conducting magnetic field lines between H and L equals the sum of the quantity of magnetic poles in H and L, the speed relationships between the three ports are as follows.

(k+1)ω_{c}=kωₗ+ωₕ (2)

ω_{c} is the angular speed of C, ωₗ is the angular speed of L, ωₕ is the angular speed of H, and k is the ratio of the quantity of magnetic poles in L to the quantity of magnetic poles in H. With this relationship, the control and operation of these magnetic gears can be very similar to the control and operation for planetary gear sets. The speeds of any two ports determine the speed of the third port.

FIG. 1(c) is a graphical representation of a disc-shaped magnetic gear system, the same configuration illustrated in FIG. 1(b). FIG. 1(d) shows a cylindrical configuration of a magnetic gear system. In both FIGS. 1(c) and 1(d), thin slanted stripes are used to represent the low-speed rotor L, thick slanted stripes are used to represent the high-speed rotor H, and the horizontal stripes are used to represent the flux conducting rotor C As shown in FIGS. 1(a), 1(b), and 1(c), L is disposed adjacent to C, and C is adjacent to H. C is disposed between L and H. In each of FIGS. 1(a), 1(b), and 1(c), L, C, and H are centered on a common axis, and are configured to revolve around the common axis. In other embodiments, L, C, and H may be on different rather than the same axes. In FIGS. 1(c) and 1(d), H is rotationally coupled to a shaft that extends along the common axis of L, C, and H.

### Magnetic Gear Ratios

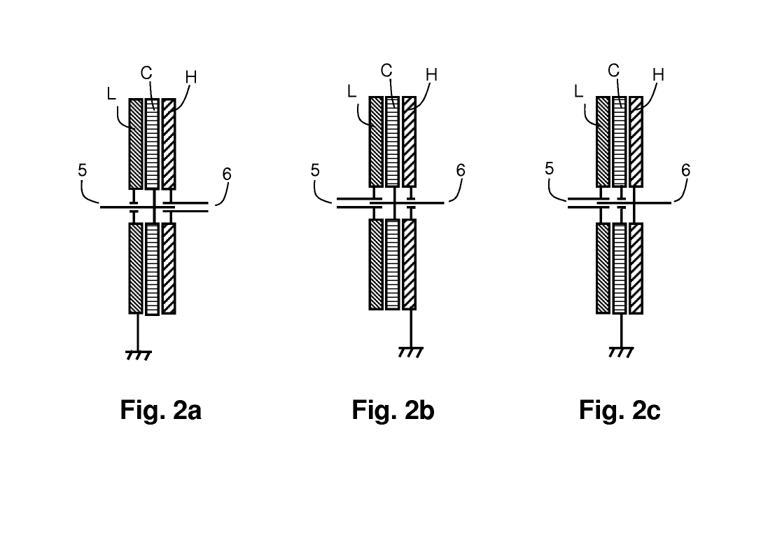

FIGS. 2(a) through 2(c) present three functionally distinct magnetic gear sets, each having a different gear ratio. The physical elements in each are the same, but the ratio of the magnetic gear set depends on how each element is connected. Fix any one input/output port so that it is stationary, and the other two ports may be used for the input and output. Three possible variations are illustrated.

In FIG. 2(a) the low-speed rotor L is fixed, and if C is the input and H is the output, then power is transmitted from the flux conducting rotor C on port 5 to the high-speed rotor H on port 6 according to equation (2); when ωₗ=0, ωₕ=(k+1)ω_{c}, so the speed of H is k+1 times the speed of C, and the speed ratio between port 6 and port 5 would be ωₕ/ω_{c}=k+1. If, instead, H (port 6) is the input port and C (port 5) is the output port, the speed ratio between port 5 and port 6 is ω_{c}/ωₕ=1/(k+1). Fixing the low-speed rotor L produces the greatest difference between the speeds and torques of the two input/output ports 5 and 6, and the direction of rotation of the two input/output ports 5 and 6 is the same.

Similarly, it can be shown from equation (2) that if the high-speed rotor H is fixed to zero speed, as shown in FIG. 2(b), the resulting gear set can have (k+1)/k (with port 6 and C as the input and port 5 and L as the output) or k/(k+1) (with port 5 and L as the input and port 6 and C as the output) for the speed ratio. This variation results in the least difference between the speed and torques of the two input/output ports 5 and 6, which both rotate in the same direction.

In the gear set shown in FIG. 2(c), the speed ratio can be −1/k (with port 6 and C as the input and port 5 and L as the output) or −k (with port 5 and L as the input and port 6 and C as the output), and the direction of rotation is reversed from the input port to the output port.

### Magnetic Gears Integrated into Electric Motors and CVTs

According to equation (2), when one of the three ports of the magnetic gear set is fixed, the speed ratio of the other two ports can be determined to be a fixed ratio if the speed of a first port is fixed to zero. If the speed of the first port is controlled at a nonzero value, then the second and third ports have a new speed ratio between them. If the speed of the control port can be continuously varied, then the speed ratio between the other two ports can be continuously variable, to form a continuously variable transmission (CVT). As known in the prior art, the magnetic gear set could be integrated into an electric motor, where the rotor of the motor shares the same set of permanent magnets as one of the magnetic rotors H and L. This shared port could then be the control port for the CVT, its speed controlled by the motor.

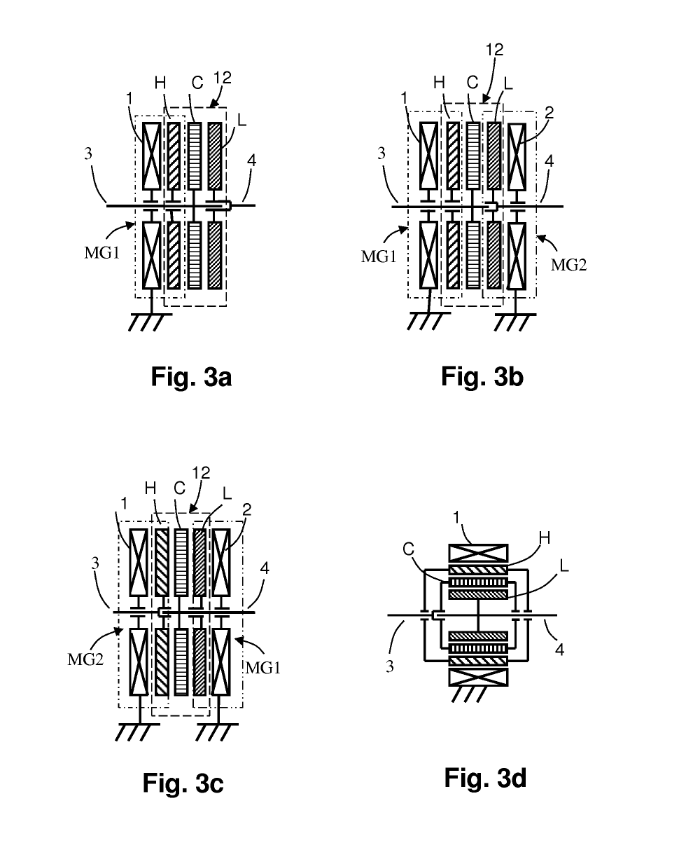

In FIG. 3(a), the magnetic gear set 12 has a stator 1 added, so that the stator 1 forms a motor MG1 with the magnetic pole rotor H, which acts as both the rotor of the motor MG1 and the high-speed rotor of the magnetic gear set. This arrangement makes for a simpler structure and can reduce cost, e.g. by using the same magnets for the motor MG1 (e.g., 1 and H) and for the magnetic gear set 12 (e.g., H, C, and L). The motor MG1 can adjust its speed and direction of rotation, so port H in the magnetic gear set 12 becomes the control port. Changing the speed of H changes the speed ratio between port C and port L. The input shaft 3 is connected to port C, and the output shaft 4 is connected to port L. The speed ratio between the input port C and the output port L is thus continuously variable, and the integrated magnetic components together form a CVT.

The variator motor MG1 may have to operate as a generator under some set of operating conditions to produce the transmission ratio desired. Adding another motor MG2 on the output port at the output shaft 4 can increase the system's power and transmission efficiency (avoiding energy conversions to and from the battery).

In an embodiment improving upon prior art, illustrated in FIG. 3(b), a second motor MG2 is comprised of the stator 2 and the low-speed magnetic pole rotor L of the magnetic gear set 12. As the second shared port, L serves as both the rotor for the motor MG2 and as the output port for the magnetic gear set 12. Power can be provided through the input shaft 3, inducing the magnetic flux conducting rotor C to rotate, while the motor MG1 can adjust the speed of the high-speed magnetic pole rotor H to produce a reaction torque that transfers a portion of the power from C to L, from which the output shaft 4 obtains output power. Another portion of the power helps the first motor MG1 to variate the speed of H, and is generated into electricity in the process; the electricity is used by the second motor MG2, which produces mechanical power on port L to be combined with the first portion. The combined output power drives the output shaft 4.

FIG. 3(c) demonstrates another dual motor configuration. Similarly to FIG. 3(b), H and L respectively form the rotors for MG1 and MG2, and there is a magnetic flux conducting rotor C in between H and L. The difference is that the input shaft 3 is connected to H, L is the control port, and MG1 variates L. C is the output port connected to the output shaft 4 in the magnetic CVT shown FIG. 3(c).

FIG. 3(d) illustrates a cylindrically structured magnetic CVT that operates similarly to the configuration shown in FIG. 3(a). The input port 3 is connected to C and the output port 4 is connected to L, similar to FIG. 3(a).

### Magnetic Clutches

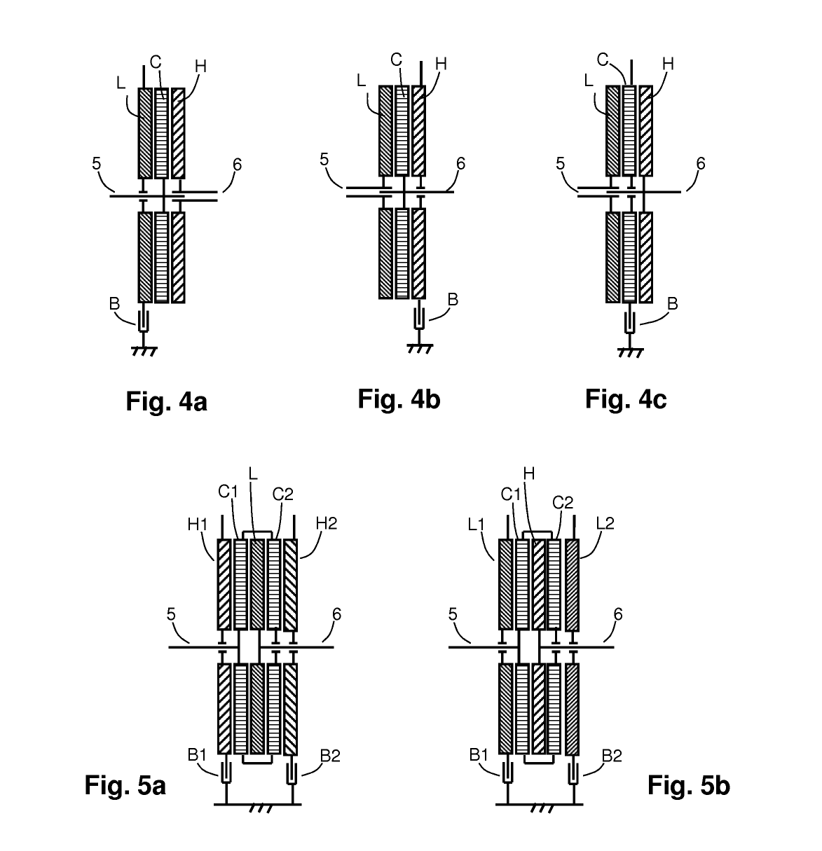

FIGS. 4(a) through 4(c) represent three functionally distinct embodiments of magnetic clutches, in arrangements similar to the gear sets described by FIGS. 2(a)-2(c). The difference between the clutch arrangements and the gear set arrangements is that instead of keeping one port stationary, a brake is connected to that port to selectively control whether that port should be configured to be stationary or configured to be freely spinning. By selecting whether the control port is fixed or is freely rotating, the brake can control whether the other two ports are coupled or decoupled. According to equation (2), when the control port is braked, the input and output ports are connected and speed and torque are transmitted at a fixed ratio, like in FIGS. 2(a) through 2(c). When the control port is released, it can freely rotate, and the other two ports can freely rotate, too.

There are three options for selecting the control port, producing three possible configurations. In FIG. 4(a), the brake B is connected to the low-speed rotor L, L being the control port and ports C and H being the input/output ports connected to the input/output shafts 5 and 6. When the brake B is closed, ports C and H are coupled to one another, and as explained with FIG. 2(a), the magnetic clutch of FIG. 4(a) can have either 1/(k+1) or k+1 for its speed ratio, depending on selection of input/output ports, and the input/output ports rotate in the same direction.

In the same way, when the control port is H, as illustrated by FIG. 4(b), ports L and C can be coupled to achieve speed ratios (k+1)/k and k/(k+1), depending on selection of input/output ports, and the direction of rotation is the same for the input port and the output port.

When the control port is C, as in FIG. 4(c), ports L and H can be coupled and decoupled. The speed ratio could be −1/k or −k, depending on which port is selected as the input and which is the output, and the direction of rotation is reversed between the input port and the output port.

### Magnetic Compound Clutches

Magnetic clutches that transmit more than one fixed gear ratio when engaged can also be constructed, which are presented in FIGS. 5(a) and 5(b). In FIG. 5(a), when the brake B1 is closed and the brake B2 is open, C1 is coupled to L, the speed ratio between ports C1 and L could be either k1/(k1+1), with L and port 6 as the input, or (k1+1)/k, with port 5, connected to both C1 and C2, as the input. If the brake B2 is closed and the brake B1 is open, C2 is also coupled to L, the speed ratio between ports C2 and L could be either k2/(k2+1) with port 5 as the input or (k2+1)/k2 with port 6 as the input. Thus each direction of power transmission can have two ratios, and the input and output ports rotate in the same direction. C1 and C2 are fixed together (e.g., by a shaft, pins, wall, or other physical connection) to rotate at the same angular velocity.

The arrangement shown in FIG. 5(b) functions similarly as the arrangement shown in FIG. 5(a) except that it uses different speed ratios, with 1/(k1+1) (port 6 and H as input) or k1+1 (port 5, affixed to C1 and C2, as the input) between ports 5 (same as C1) and L, and 1/(k2+1), if port 6 is the input, or k2+1, if port 5 is the input, between ports 5 (same as C2) and L. The input port and output port in this arrangement also rotate in the same direction.

### Magnetic Differential

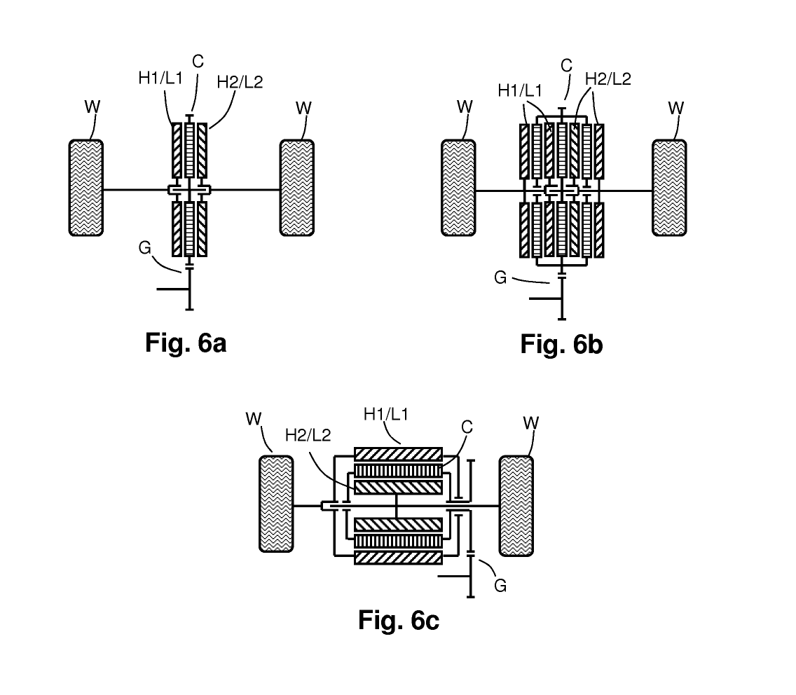

With the magnetic flux conducting rotor C as the input and the high-speed and/or low-speed rotors as output, magnetic differential gears can be constructed from the structure explained in either FIG. 5(a) or FIG. 5(b). The two magnetic rotors (denoted H1/L1 and H2/L2) in a magnetic differential gear set may have the same quantity of magnetic poles for relatively symmetrical output, as illustrated in FIGS. 6(a) through 6(c). When the input ω_{c} is known, then if one of the two magnetic pole rotors spins at a decreased speed, the other magnetic pole rotor spins at an increased speed to maintain the speed relationship of equation (2). For instance, when the vehicle is making a turn, the wheel on the inner trajectory has its speed decreased, and the wheel on the outer trajectory has its speed increased automatically with such a magnetic differential gear. FIG. 6(a) shows a differential comprised of a single magnetic gear set. Such a magnetic differential may be more efficient than a mechanical differential, and may perform better at lower temperatures. (Whereas mechanical differential drives rely on oil that can turn viscous at colder temperatures, magnetic flux density actually increases as temperature gets colder.)

To decrease the radius of the magnetic gears while maintaining the same torque density, the multi-layered configuration shown in FIG. 6(b), with a plurality of magnetic rotors and flux conducting rotors, may be used. As shown in FIG. 6(b), the magnetic differential can include multiple gear sets, each having a first rotatable element (H1/L1) including a first plurality of permanent magnets having a respective first additional quantity of pole-pairs that move with the first rotatable element (H1/L1), each first rotatable element (H1/L1) being connected to the other first rotatable element (H1/L1) in the multiple gear sets and to the first differential output port. Each of the multiple gear sets can also include a second rotatable element (H2/L2) including a second plurality of permanent magnets having a respective second additional quantity of pole-pairs that move with the second rotatable element (H2/L2), each second rotatable element (H2/L2) being connected to the other second rotatable elements (H2/L2) in the multiple gear sets and to the second differential output port. Each of the multiple gear sets can also include a third rotatable element (C) having a plurality of magnetic flux conducting pole-pieces that move with the third rotatable element (C), each third rotatable element (C) being connected to the other third rotatable element (C) in the multiple gear sets and to the differential input port. Each of the first additional rotatable element H1/L1, the second additional rotatable element H2/L2, and the third additional rotatable element C is configured to provide additional surface area to transmit torque between the differential input port and the differential output ports.

FIG. 6(c) illustrates another configuration for a cylindrically constructed magnetic differential, which functions similarly to FIG. 6(a).

### Kinetic Power System

Magnetic gear systems can also be combined with a flywheel to form magnetically controlled kinetic power systems. Advantageously, a magnetically integrated flywheel can be sealed into a vacuum, and flywheel spin losses can be significantly reduced when there is no air friction.

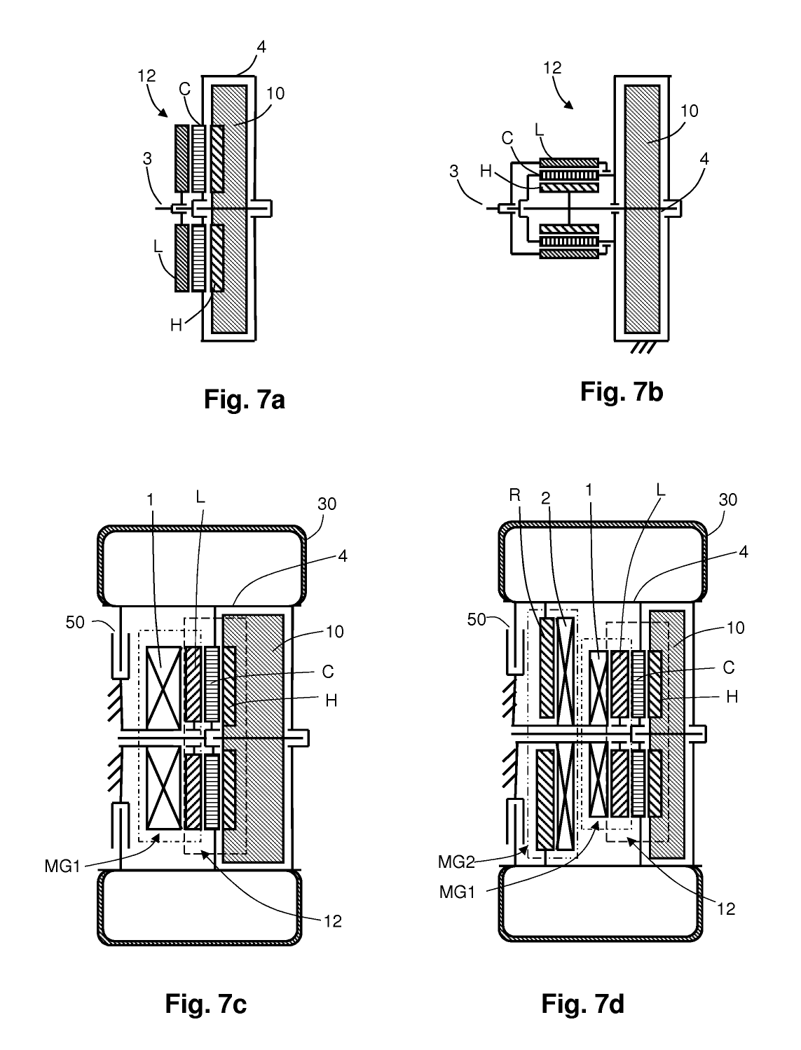

In the magnetically integrated kinetic power system of FIG. 7(a), the high-speed magnetic pole rotor H of the magnetic gear set 12 is integrated into (or connected to) the flywheel 10, and the magnetic flux conducting rotor C of the magnetic gear set 12 is part of the structure containing the flywheel 4, which may be rotatable, so that 4 also represents the output port, which can for instance be a wheel rim with the flywheel 10 inside. The low-speed magnetic pole rotor L of the magnetic gear set 12 is the control port, variating the speed ratio between the input port H for the flywheel 10 and the output port C (also 4). Variating the speed ratio in turn controls the storage and release of kinetic energy and power from the flywheel 10. FIG. 7(b) uses a cylindrical structure integrated with the flywheel 10, which can also be sealed in a vacuum, and operates similarly to the configuration shown in FIG. 7(a).

The kinetic-electric CVT of FIG. 7(c) differs from the kinetic system of FIG. 7(a) in that there is an integrated motor MG1 that uses a stator 1 to control L (also the rotor of MG1), and the system can be installed into a wheel hub to form a wheel hub kinetic power system. The motor MG1, comprised of a stator 1 and rotor L, can control the speed ratio between ports C and H and thus control the storage and release of kinetic energy to and from the flywheel 10. When the vehicle decelerates, kinetic energy is transferred to port C, and a portion of the kinetic energy is directly stored into the flywheel 10, increasing the speed of the flywheel 10, while another portion of the kinetic energy passes through the stator 1, and becomes electricity to be stored into a battery pack. When the vehicle accelerates, MG1 comprised of 1 and L can control the release of kinetic energy from the flywheel 10 to the wheel of the vehicle by varying the speed ratio between ports C and H. Of the three ports in the magnetic gear set 12, two ports/rotors are shared: H is integrated into the flywheel 10, and L is integrated into the motor MG1.

FIG. 7(d) is the configuration of FIG. 7(c) with an additional second motor MG2, comprised of a stator 2 and an additional rotor R. The purpose of MG2 is to reuse the electricity generated by MG1 (comprised of 1 and L) to produce mechanical power directly on port C and also drive the vehicle instead of storing the energy into the battery pack. Compared to the kinetic-electric CVT configuration of FIG. 7(c), the CVT embodiment of FIG. 7(d) increases efficiency, decreases the current used to charge the for the battery pack, and thereby extends the battery life.

### Magnetic Transmission

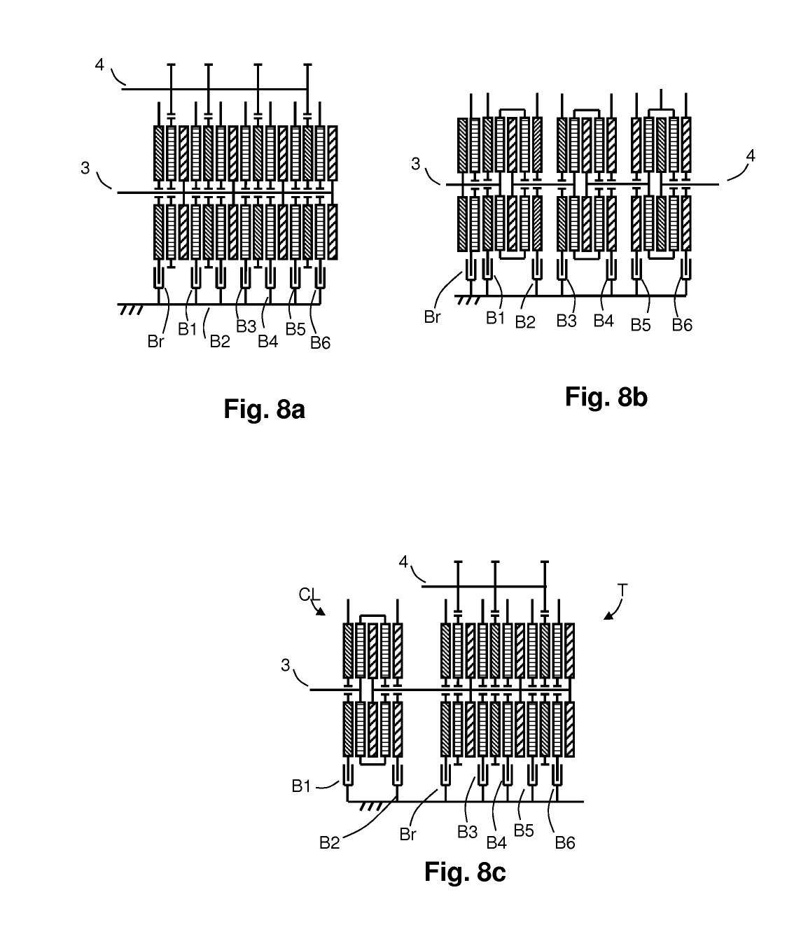

FIG. 8(a) shows a parallel type magnetic transmission, comprised of many magnetic clutches having various gear ratios (refer to FIGS. 3(a)-3(c)). These magnetic clutches are connected in parallel across the input shaft 3 and the output shaft 4; individual gear selectors comprised of the brakes Br, B1, B2, B3, B4, B5, and B6 are used to select the gear ratio used to transfer power between the input shaft 3 and the output shaft 4, with only one brake applied at a time. The brake Br is connected to a first magnetic clutch that does not change the direction of rotation between input and output, but as the output shaft 4 reverses the direction of rotation, when Br is braked the transmission is on reverse gear. The other brakes B1-B6 control the six forward gears using the magnetic clutch configuration from FIG. 3(c). From the input shaft 3 to the output shaft 4 there will be two changes in the direction of rotation, so the input and output will be in the same direction.

FIG. 8(b) illustrates an alternative, “series” type magnetic transmission, comprised of various magnetic clutches (from FIGS. 4(a) and 3(c)). The magnetic compound clutches are connected in series between the input shaft 3 and output shaft 4. Each compound magnetic clutch can control the brakes to produce two different speed ratios, and because the compound magnetic clutches are connected in series, eight different speed ratios can be produced multiplicatively between the input and the output, making for eight gear speeds. The brake Br controls reverse gear, and the brakes B1-B6 control the eight forward gears. Around half the brakes are applied to obtain each gear ratio from the input shaft 3 to the output shaft 4 of the transmission.

The magnetic transmission of FIG. 8(c) is comprised of at least one compound magnetic clutch C with a group of parallel magnetic clutches or a parallel type magnetic transmission T to form a “mixed” type magnetic transmission. It is understood that, although not shown in the figure, more compound magnetic clutches can be used in the mixed type magnetic transmission. In the non-limiting example drawn in FIG. 8(c), the transmission has eight forward speeds and two reverse speeds, with its transmission ratio at any given moment being the multiplicative sum of the ratios from C and T.

### Magnetic Powertrain in a Conventional Vehicle

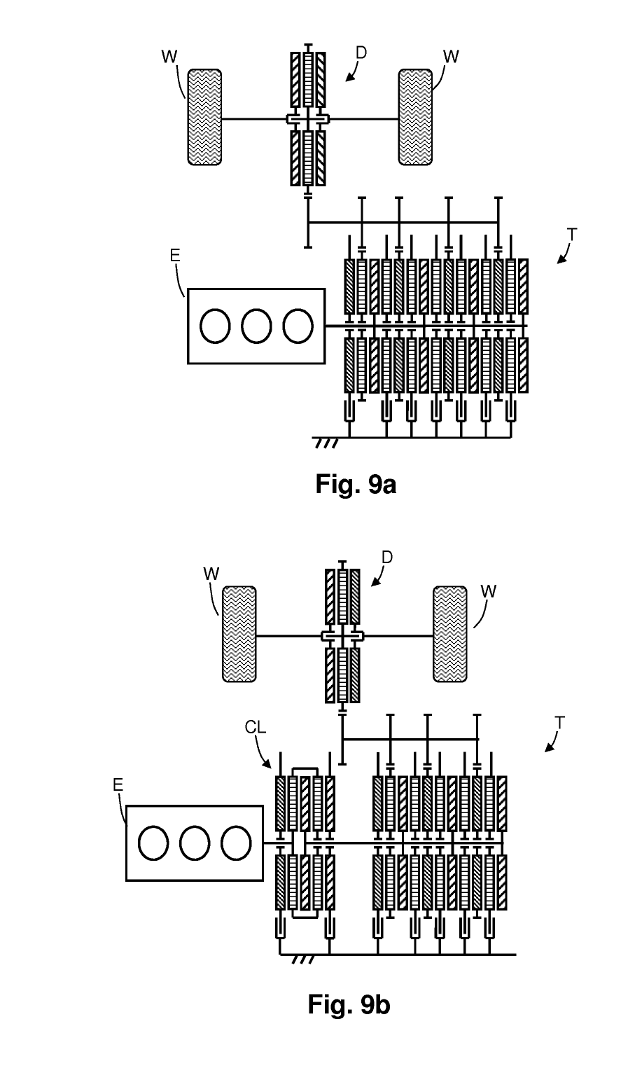

FIGS. 9(a) and 9(b) present powertrains utilizing a magnetic differential and a magnetic transmission for a vehicle powered by internal combustion. FIG. 9(a) uses a parallel type magnetic transmission that has six forward speeds and one reverse speed. E represents the engine, D represents the differential, T represents the transmission, and W represents the wheels. FIG. 9(b) differs in that a mixed type magnetic transmission is used instead, increasing the quantity of speeds the transmission can offer, and reducing the quantity of magnets used. The mixed type magnetic transmission drawn in FIG. 9(b) has eight forward speeds as well as two reverse speeds.

### Magnetic Powertrain with a Kinetic Power System

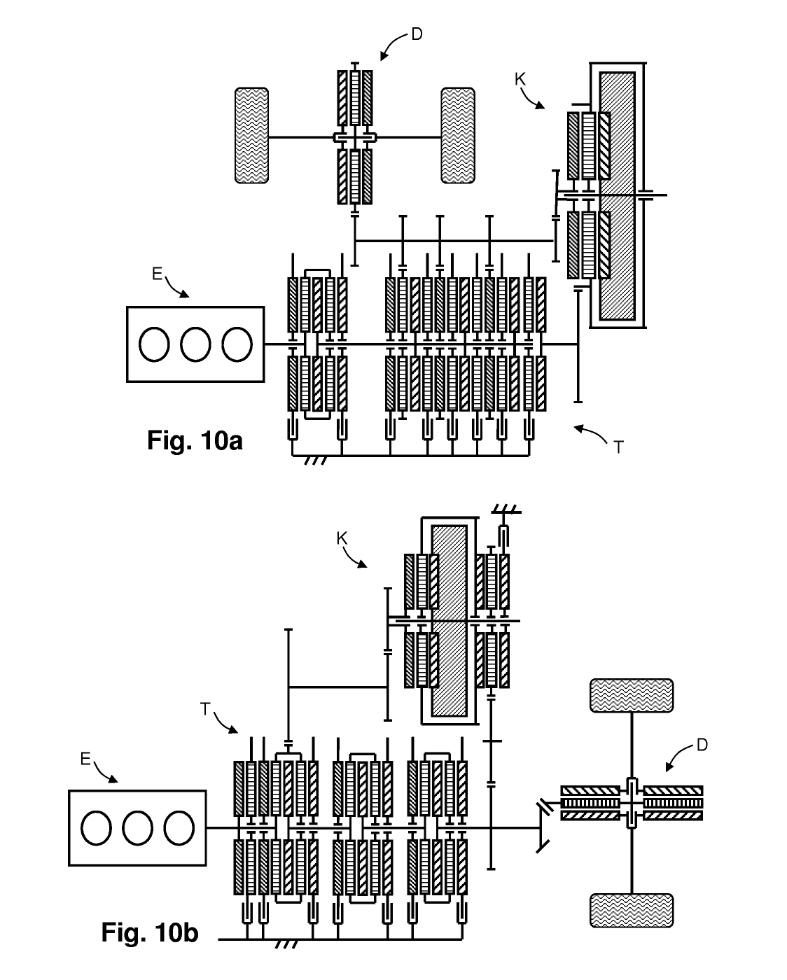

FIGS. 10(a) and 10(b) show powertrains for a vehicle also having a kinetic power source, utilizing the magnetic transmission, magnetically controlled kinetic power system(s) (explained in FIG. 7(a)), and magnetic differential. The configuration seen in FIG. 10(a) differs from the configuration in FIG. 9(b) in that there is now a kinetic power system K. The speed ratios provided by the transmission T can control the storage and release of kinetic energy from the flywheel in the kinetic power system K to increase the vehicle's fuel efficiency. FIG. 10(b) has a configuration that differs from that shown in FIG. 10(a) in that it uses a series type magnetic transmission instead of a mixed type magnetic transmission.

### Magnetic Powertrain for an Electric Vehicle

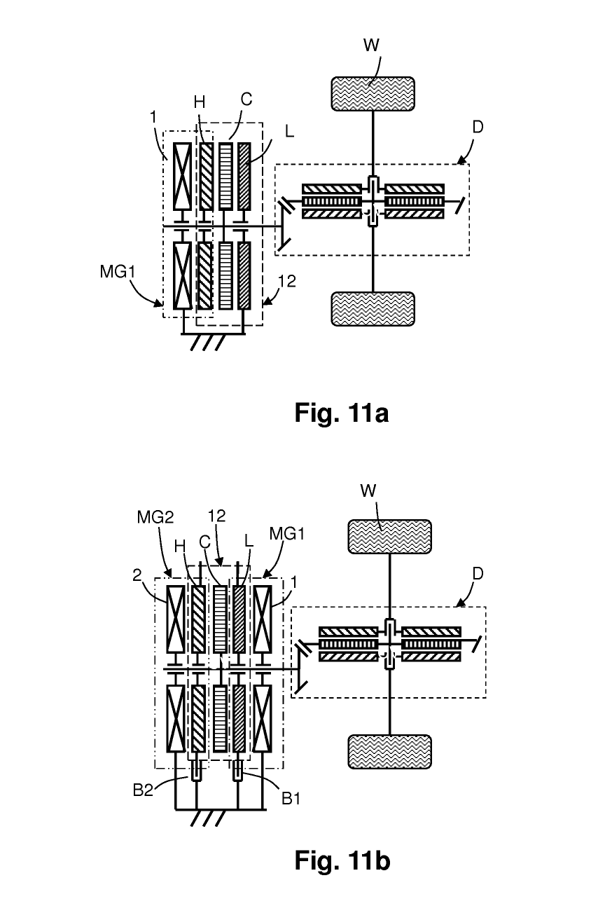

A magnetic powertrain for an electric vehicle is drawn in FIG. 11(a). In the magnetic gear set 12, port L is fixed to the chassis, port C is the output port, port H is the input port as well as the rotor for the motor MG1, and 1 is the stator of the motor MG1, also secured to the chassis. The ratio between the magnetic gears H and C is k+1; the figure shows a single motor driving the vehicle at a fixed gear ratio, with the power from the motor passing through the magnetic gear set; the torque is multiplied by k+1 and passes through the magnetic differential gear D to drive the wheels W.

In FIG. 11(b), a dual-motor electric vehicle powertrain is shown. The magnetic gear set 12, with two motors MG1 and MG2 integrated into it, is configured as a CVT with port C as the output port, and with both L and H, respectively the rotors of MG1 and MG2, as input ports and as control ports for the CVT. When both motors are in operation, both brakes B1 and B2 are open, and either MG1 can vary the speed ratio between MG2 and the output port, or MG2 can vary the speed ratio between MG1 and the output port. The speed ratio of the CVT is continuously variable across a large range of vehicle speeds, and at higher vehicle speeds both motors can work simultaneously, providing higher torque. There are also two operation states involving only one motor driving the vehicle. When the brake B1 is closed, but B2 is open, the motor MG1 is not used, and MG2 works alone to drive the magnetic gear system at a speed ratio of k+1, suitable for one range of vehicle speeds. When the brake B2 is closed, but B1 is open, the motor MG2 is not used, and MG1 works alone to drive the vehicle at a speed ratio of (k+1)/k, suitable for another range of vehicle speeds. In addition to the dual motor operation state, the two single-motor operation states of this powertrain allow the traction motor(s) to work at high efficiency.

### Magnetic Powertrain for a Hybrid Vehicle

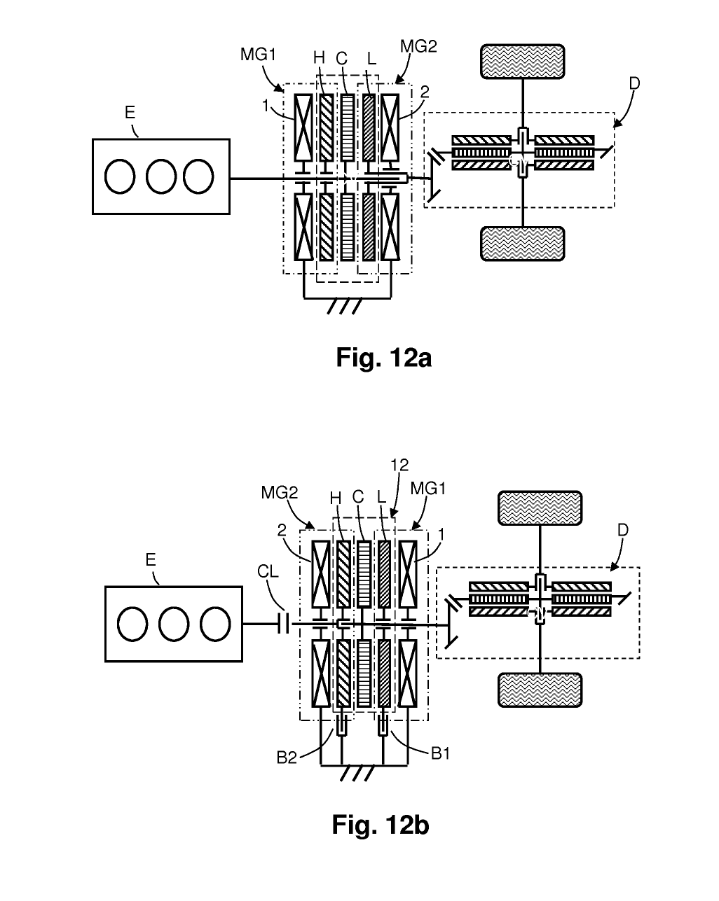

FIGS. 12(a) and 12(b) present powertrains for an electric hybrid vehicle wherein the powertrains are integrated using magnetic gears. In FIG. 12(a), the magnetic CVT comprised of the magnetic gear set 12, the motor MG1, and the motor MG2, can serve as the transmission for the engine E. The motor MG1, comprised of a stator 1 and a rotor H, is the motor controlling the ratio of the CVT. MG2 is the traction motor with L as its rotor and 2 as its stator. L is the output port, and power from the engine E, transmitted through the magnetic gear CVT controlled by MG1, combines at port L with the electric power provided by MG2 to drive the vehicle through the differential D. The vehicle may also be driven by the engine E alone or by the motor MG2 alone.

FIG. 12(b) demonstrates another configuration. For this alternative powertrain, the input port is H, and the output port is C. When the engine E is in use, the magnetic gear system is its CVT, with the motor MG1 controlling the CVT ratio, and the motor MG2 is the traction motor that can provide power along with the engine E. When the engine E is not in use, the powertrain of FIG. 12(b) is an electric vehicle.

### Magnetic Powertrain for a Hybrid Vehicle Having a Kinetic Power System

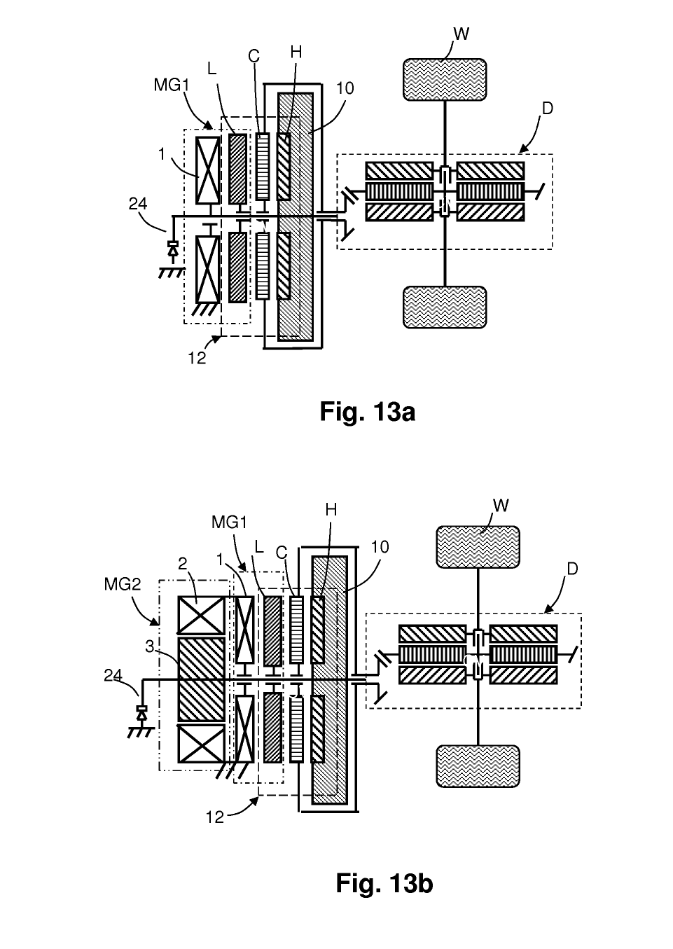

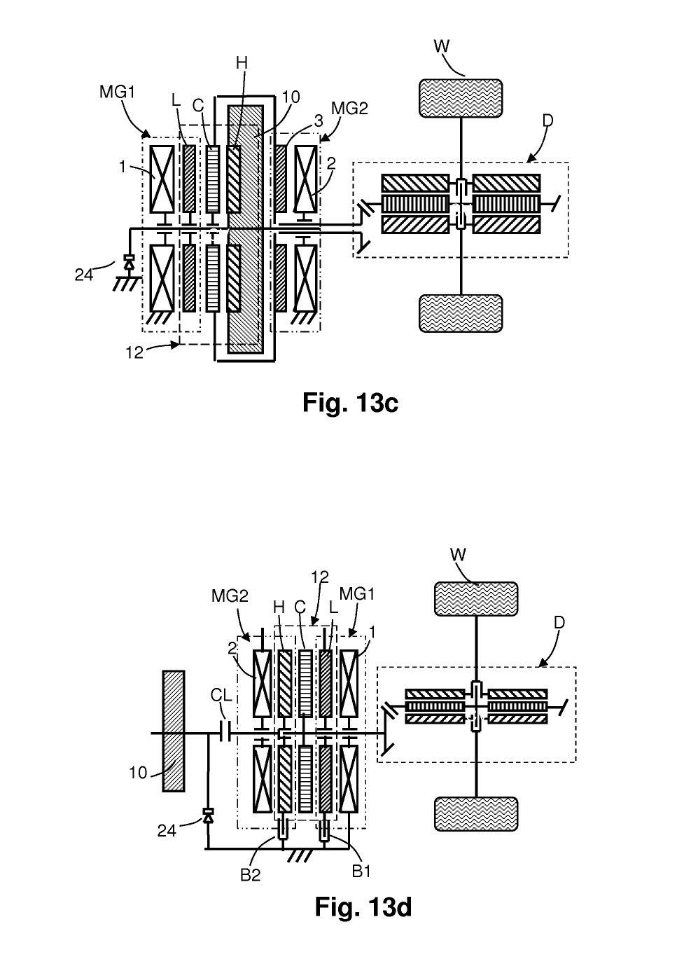

FIG. 13(a) shows the configuration of FIG. 7(a) with a set of stator windings 1 integrated with L of the magnetic gear set 12 to form a motor MG1. Note that the C is the output port of the magnetic gear system, providing its output to the wheels W through the differential D. H of the magnetic gear set 12 is integrated with the flywheel 10. The motor MG1 controls the speed ratio between C and H, which in turn controls the exchange of kinetic energy between the vehicle and the flywheel to accelerate and decelerate the vehicle. When the motor MG1 drives the vehicle, the kinetic energy in the flywheel 10 can be released to zero, and then due to the one-way clutch 24, the flywheel 10 is locked to the chassis, and H is fixed to be stationary, allowing the motor MG1 to drive the vehicle at the fixed speed ratio of (k+1)/k.

FIG. 13(b) introduces a second motor MG2 on port H of the configuration of FIG. 13(a), and MG2 serves to absorb the electricity generated by MG1 in controlling the CVT ratio and reuses the electricity back to the powertrain, combining its torque with the power from the flywheel 10 to accelerate the vehicle. Compared to the single motor configuration shown in FIG. 13(a), the dual motor configuration of FIG. 13(b) can reduce the current to the battery pack, increasing efficiency and extending battery life.

FIG. 13(c) also adds a second motor MG2 to the configuration of FIG. 13(a), but MG2 in FIG. 13(c) is on port C. MG2 serves to absorb the electricity generated by MG1 in controlling the CVT ratio and reuses the electricity back to the powertrain to drive the vehicle, which increases efficiency and improves battery life, by virtue of reducing the current to and from the battery pack.

The configuration of FIG. 13(d) results from adding a flywheel 10 to port H of the powertrain of FIG. 11(b). The motor MG1 controls the storage and release of energy to and from the flywheel 10 by changing the speed ratio between the input port (e.g. H) and the output port (e.g. C) of the kinetic-electric CVT assembly. When there is a demand for a change in the vehicle speed, the flywheel 10 can exchange kinetic energy with the vehicle to produce the desired change in vehicle speed. The electricity generated by MG1 is reused by MG2 as mechanical power back to the powertrain to be combined with the power from the flywheel 10 to drive the vehicle while reducing the current to and from the battery pack, increasing efficiency and extending battery life. The motor MG2 can also charge up the flywheel 10 anytime. When the flywheel 10 is not needed the flywheel 10 can be disengaged using the clutch CL.

### Magnetic Powertrain for a Kinetic-Fuel-Electric Hybrid Vehicle

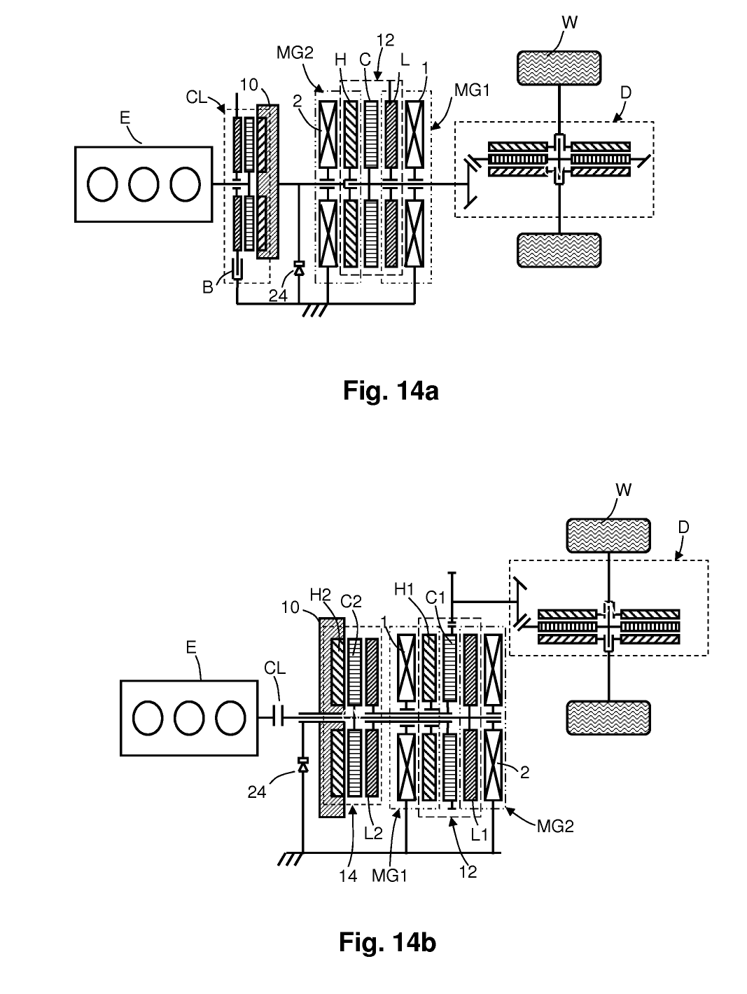

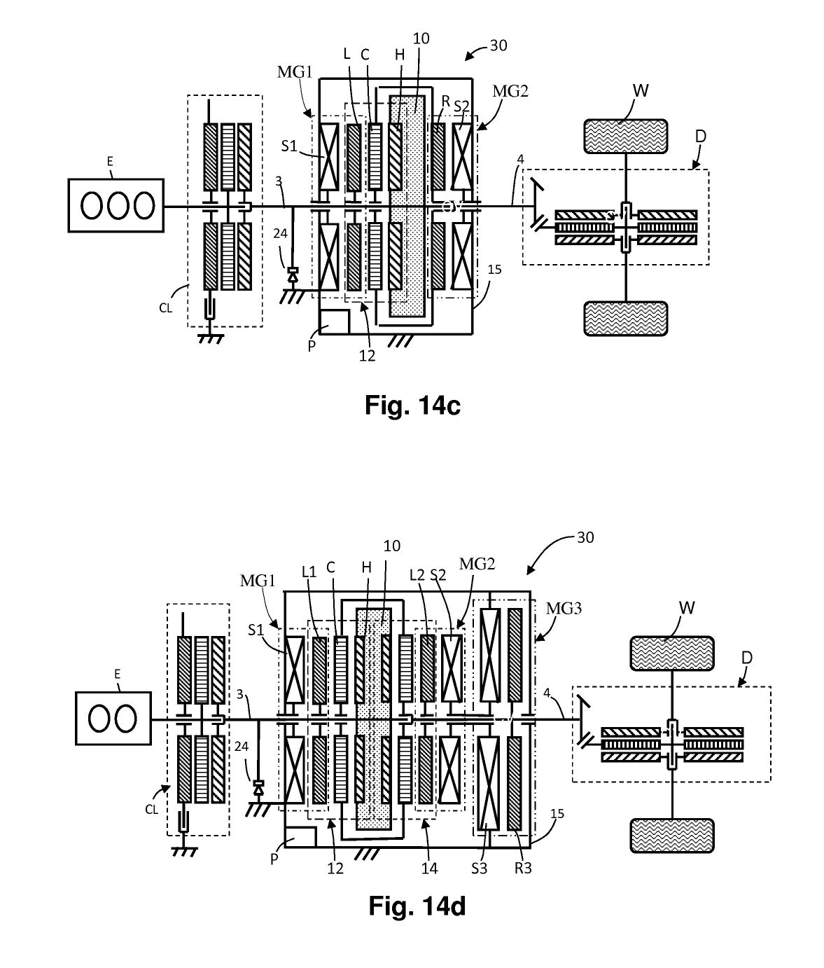

The powertrain configuration of FIG. 14(a) uses the powertrain of FIG. 13(d), connecting the flywheel 10 to an internal combustion engine E using the magnetic gear clutch CL, forming a hybrid vehicle powertrain with three sources of power. The motor MG2 can charge the flywheel 10 and/or start the engine E. The magnetic gear clutch CL has a gear ratio that enables the engine E and the flywheel 10 to simultaneously operate at the best efficiency for the engine E. The engine E or the motor MG2 provides the flywheel 10 with energy to drive the vehicle. MG1 is the motor controlling the CVT ratio, which in turn controls the storage and release of energy from the flywheel 10.

FIG. 14(b) shows a four-port compound power split continuously variable transmission comprised of magnetic components for a hybrid vehicle. The variator motor MG1 is coupled to H1 of a first magnetic gear set 12, the flywheel 10 is coupled to H2 of a second magnetic gear set 14, and C1 of 12 and L2 of 14 comprise a third output port transmitting power through the differential D to drive the wheels W. C2 of 14 and L1 of 12 comprise a fourth port coupled to the engine E as well as the traction motor MG2.

In FIG. 14(c), the flywheel 10, motor MG1 and motor MG2 are all integrated together with magnetic gears (magnetic gear set 12) so that these components comprise one kinetic-electric hybrid CVT assembly 30 that may be housed within the container 15. The kinetic-electric hybrid CVT assembly 30 also serves as kinetic and electric power sources for the hybrid powertrain. The input port 3 to the CVT assembly 30 is coupled to the engine E through the magnetic clutch CL and is connected to the flywheel 10 and the high-speed rotor H of the magnetic gear set 12. The output port 4 of the kinetic-electric hybrid CVT assembly 30 leads to the differential D and is connected to the rotor R of the motor MG2, and to the flux conducting rotor C that may be embedded into a rotatable containment case of the flywheel 10. The flywheel 10 may be sealed in a vacuum, or there may be an optional pump P within the CVT assembly 30 that circulates air and keeps the air pressure low. In such a hybrid powertrain, the engine E and the motor MG2 can be considered the primary power sources, with the flywheel 10 as the secondary power source and energy storage. MG1 functions as the variator motor to the kinetic-electric hybrid CVT assembly 30. The gear ratios may be designed such that when the engine E charges the flywheel 10 an optimal efficiency is achieved. There may be a air pump P enclosed within the kinetic-electric hybrid CVT assembly 30.

The hybrid powertrain of FIG. 14(d) builds on the concept of the powertrain described by FIG. 14(c), and can improve upon its efficiency. Compared to FIG. 14(c), the kinetic-electric CVT 30 of FIG. 14(d) has two motors (both MG1 and MG2) to variate the CVT ratio. With only one motor to control the CVT ratio over an entire range of vehicle operation conditions, there may be moments when the motor speed goes from positive or negative or negative to positive. At the point where motor speed is zero, the motor stalls and efficiency is zero. With two motors to control the CVT ratio, the gear ratios between L1 and H and L2 and H may be designed to be different, thus enabling either MG1 or MG2, or both, to variate CVT ratio. The stall point for both the variator motors can be avoided this way, so the CVT 30 may be more efficient across the entire range of vehicle operation conditions. MG3 represents a traction motor, which is a power source for the powertrain that can use electricity generated by either MG1 or MG2.

What is claimed is:

1. A magnetic clutch, comprising:
i. a first rotatable element comprising a first plurality of permanent magnets having a respective first quantity of pole-pairs that move with the first rotatable element;
ii. a second rotatable element comprising a second plurality of permanent magnets having a respective second quantity of pole-pairs that move with the second rotatable element;
iii. a third rotatable element comprising a plurality of magnetic flux conducting pole-pieces that move with the third rotatable element and modulate the magnetic field between the first and second rotatable elements; and
iv. a brake connected to one of the first, second, and third rotatable elements.

2. The magnetic clutch of claim 1, wherein the magnetic clutch further comprises:
i. a fourth rotatable element comprising a third plurality of permanent magnets having a respective third quantity of pole-pairs that move with the fourth rotatable element;
ii. a brake connected to the fourth rotatable element; and
iii. a fifth rotatable element comprising a second plurality of magnetic flux conducting pole-pieces that move with the fifth rotatable element and modulate the magnetic field between the second and fourth rotatable elements, wherein the fifth rotatable element is connected to the third rotatable element.

3. A magnetic differential gear drive, comprising:
i. a differential input port
ii. a first differential output port;
iii. a second differential output port; and
iv. a first gear set that includes:
a. a first rotatable element comprising a first plurality of permanent magnets having a respective first quantity of pole-pairs that move with the first rotatable element, the first rotatable element being connected to the first differential output port;
b. a second rotatable element comprising a second plurality of permanent magnets having a respective second quantity of pole-pairs that move with the second rotatable element, the second rotatable element being connected to the second differential output port; and
c. a third rotatable element comprising a plurality of magnetic flux conducting pole-pieces that move with the third rotatable element and modulate the magnetic field between the first and second rotatable elements, the third rotatable element being connected to the differential input port.

4. The magnetic differential of claim 3, wherein the first quantity of pole-pairs in the first rotatable element and the second quantity of pole-pairs in the second rotatable element are equal.

5. The magnetic differential of claim 3, wherein the magnetic differential is configured as part of a vehicle powertrain, and the first and second differential output ports are each connected to a wheel of the vehicle.

6. The magnetic differential of claim 3, further comprising
i. at least one additional gear set, each additional gear set including
a. a first additional rotatable element comprising a first additional plurality of permanent magnets having a respective first additional quantity of pole-pairs that move with the first additional rotatable element, each first additional rotatable element and the first rotatable element being connected to each other and to the first differential output port;
b. a second additional rotatable element comprising a second additional plurality of permanent magnets having a respective second additional quantity of pole-pairs that move with the second additional rotatable element, each second additional rotatable element and the second rotatable element being connected to each other and to the second differential output port; and
c. a third additional rotatable element comprising a third additional plurality of permanent magnets having a respective third additional quantity of pole-pairs that move with the third additional rotatable element, each third additional rotatable element and the third rotatable element being connected to each other and to the differential input port,
wherein each of the first additional rotatable element, the second additional rotatable element, and the third additional rotatable element is configured to provide additional surface area to transmit torque between the differential input port and the differential output ports.

7. A magnetic CVT for a vehicle, comprising:
i. a magnetic gear set configured as a continuously variable transmission comprising a first port, a second port, and a third port;
ii. a first integrated electric motor, comprising a first rotatable element as its rotor and a first set of stator windings configured to produce a magnetic field that acts on the first rotatable element on the first port, wherein the first rotatable element comprises a first plurality of permanent magnets having a respective first quantity of pole-pairs that moves with the first rotatable element, and the first rotatable element is connected to the first port;
iii. a second integrated electric motor, comprising a second rotatable element as its rotor and a second set of stator windings configured to produce a magnetic field that acts on the second rotatable element on the second port, wherein the second rotatable element comprises a second plurality of permanent magnets having a respective second quantity of pole-pairs that moves with the second rotatable element, connected to the second port; and
iv. a third rotatable element comprising a plurality of magnetic flux conducting pole-pieces that move with the third rotatable element and modulate the magnetic field between the first and second rotatable elements, the third rotatable element being connected to the third port.

8. The magnetic CVT of claim 7, wherein the third port of the magnetic CVT is the input port, and one of the first and second ports of the magnetic CVT is the output port, and wherein one of the first and second motors acts on a remaining one of the first and second ports to control the speed ratio between the input port and the output port.

9. The magnetic CVT of claim 7, wherein one of the first and second ports is an input port of the magnetic CVT, and the third port is an output port of the magnetic CVT, and wherein one of the first and second motors acts on a remaining one of the first and second ports to control the speed ratio between the input port and the output port.

10. The magnetic CVT of claim 9, wherein the input port of the magnetic CVT is coupled to an internal combustion engine, and the magnetic CVT is configured as a transmission for the internal combustion engine.

11. A kinetic-electric hybrid CVT assembly for a vehicle, comprising:
i. a magnetic gear set configured as a continuously variable transmission comprising a first port, a second port, and a third port;
ii. a first rotatable element comprising a flywheel and a first plurality of permanent magnets having a respective first quantity of pole-pairs that move with the first rotatable element, the first rotatable element being connected to the first port;
iii. a second rotatable element comprising a second plurality of permanent magnets having a respective second quantity of pole-pairs that move with the second rotatable element, the second rotatable element being connected to the second port;
iv. a third rotatable element comprising a plurality of magnetic flux conducting pole-pieces that move with the third rotatable element and modulate the magnetic field between the first and second rotatable elements, the third rotatable element being connected to the third port; and
v. a first electric motor coupled to the second port of the kinetic-electric hybrid CVT assembly.

12. The kinetic-electric hybrid CVT assembly of claim 11, wherein the first electric motor is coupled to the second port of the assembly through magnetic gears.

13. The kinetic-electric hybrid CVT assembly of claim 11, wherein the first electric motor comprises the second rotatable element as its rotor and a first stator.

14. The kinetic-electric hybrid CVT assembly of claim 11, further comprising a second electric motor coupled to one of the first and third ports.

15. The kinetic-electric hybrid CVT assembly of claim 14, wherein the second electric motor comprises a second stator and a second rotor, wherein the second rotor is connected to the third port of the assembly, and the second electric motor is configured to control the speed of the third port.

16. The kinetic-electric hybrid CVT assembly of claim 11, further comprising a plurality of electric motors coupled to the third port.

17. The kinetic-electric hybrid CVT assembly of claim 11, wherein the first rotatable element including the flywheel is enclosed in a vacuum.

18. The kinetic-electric hybrid CVT assembly of claim 11, wherein the first rotable element further includes a vacuum housing, and the second port is connected to the vacuum housing for the first rotatable element.

19. The kinetic-electric hybrid CVT assembly of claim 11, wherein the kinetic-electric hybrid CVT assembly is configured as a transmission for an internal combustion engine that is coupled to one of the first and third ports.

20. The kinetic-electric hybrid CVT assembly of claim 19, wherein the internal combustion engine is coupled to the kinetic-electric hybrid CVT assembly through a gear set.
